(19) United States
(12) Patent Application Publication
(10) Pub. No.: US 2025/0230707 A1
(43) Pub. Date: Jul. 17, 2025

(54) Glass for Reducing Bird Collisions

(71) Applicant: Vitro Flat Glass LLC, Cheswick, PA (US)

(72) Inventor: Michael J. Buchanan, Cheswick, PA (US)

(21) Appl. No.: 19/020,816

(22) Filed: Jan. 14, 2025

Related U.S. Application Data
(60) Provisional application No. 63/621,135, filed on Jan. 16, 2024.

(51) Int. Cl. E06B 9/24; C03C 17/00; C03C 17/22; C03C 17/245

(52) U.S. Cl. CPC E06B 9/24; C03C 17/007; C03C 17/225; C03C 17/245; C03C 2217/21; C03C 2217/281; C03C 2217/42; C03C 2217/74; C03C 2218/156; E06B 2009/2405

(57) ABSTRACT

A coated substrate, such as an architectural window, for reducing bird collisions comprising a first substrate, having a No. 1 surface and a No. 2 surface oppositely disposed from the No. 1 surface, wherein the No. 2 surface comprises at least one functional layer located thereon, and wherein the No. 1 surface includes a first coating having a predetermined pattern that creates a contrast in the UV and/or bird-visible range when compared to uncoated portions of the No. 1 surface of the substrate or when compared to other coated portions of the No. 1 surface. The coated substrate can be used as a single substrate in an architecture window or as a substrate in an insulating glass unit. A method for forming the architectural window for reducing bird collisions using a sputter-up and sputter-down process is also provided.

### CROSS-REFERENCE TO RELATED APPLICATION

This application claims the benefit of U.S. Provisional Patent Application No. 63/621,135, filed Jan. 16, 2024, which is incorporated herein by reference in its entirety.

### BACKGROUND OF THE INVENTION

### Field of the Invention

The invention relates to an architectural window, and more particularly, to an architectural window having a coating pattern on a surface of the window, such as the exterior or No. 1 surface, which aids in reducing bird collisions.

### Background of the Invention

To reduce energy losses and improve the comfort in buildings, windows with high thermal performance are needed. These windows often have a high reflectance that reflects the sky and landscape, which can be detrimental to the bird population. It is estimated that approximately one billion birds die in the United States each year after collisions with windows. The collisions are caused due to the fact that the substrate of the window reflects the sky and landscape behind the bird, such that the bird perceives that its flight path is open.

Windows having high thermal performance that are designed to reduce bird collisions and a cost-effective technique for producing these types of windows would be desirable.

### SUMMARY OF THE INVENTION

In accordance with one aspect, the present disclosure is directed to a coated substrate such as an architectural window, comprising a first substrate, the first substrate having a No. 1 surface and a No. 2 surface oppositely disposed from the No. 1 surface. The No. 2 surface comprises at least one functional layer located thereon, and the No. 1 surface includes a first coating having a bird-visible predetermined pattern on a portion of the No. 1 surface with respect to other portions of the No. 1 surface. The first coating can comprise nanoparticles. The first coating can comprise silicon nitride or various oxides, such as titanium dioxide, zinc oxide, tin oxide, and/or zinc stannate. According to one embodiment, the first coating can be applied to the No. 1 surface. The first coating is applied in a manner to produce a predetermined pattern. The predetermined pattern can comprise a series of spaced markings. The predetermined pattern can be created using a mask. According to another embodiment, the predetermined pattern can comprise a series of stripes. The predetermined pattern forms a contrasting surface on the first substrate in comparison to other portions of the No. 1 surface of the substrate. This contrasting surface reduces bird collisions with the window.

According to one embodiment, the at least one functional layer located on the No. 2 surface can comprise at least a base layer, at least one metallic layer, and a top layer. At least one primer layer can be positioned over the at least one metallic layer. Also, at least one protective layer can be positioned over the top layer.

In accordance with another aspect, the present invention is directed to a method of forming an architectural window for reducing bird collisions with the window. The method comprises providing a first substrate having a No. 1 surface and an oppositely disposed No. 2 surface, moving the substrate through a coating device, wherein a mask can be located within the coating device, applying a first coating to the No. 1 surface, wherein the first coating has a predetermined pattern, created by the pattern of the mask, that forms a contrasting surface on the substrate, and applying a second coating to the No. 2 surface, wherein the second coating comprises a plurality of layers that form a functional layer on the No. 2 surface, wherein the predetermined pattern results in a contrast in the UV (ultraviolet) and/or visible light range when compared to other portions of the No. 1 surface of the substrate. According to one embodiment, the coating device can be a magnetron sputter vapor deposition (MSVD) coating device and the second coating can be applied to the No. 2 surface using a sputter-down process and the first coating can be applied to the No. 1 surface in the MSVD coating device using a sputter-up process. The method further comprises continuously moving the substrate through the coating device and applying the second coating to the No. 2 surface and the first coating to the No. 1 surface in a single pass of the substrate through the MSVD coating device. The predetermined pattern can be a striped pattern on the No. 1 surface. Alternatively, the first coating can be selectively applied to the No. 1 surface by turning on/off the coating device that controls the application of the first coating. The pattern of the coating can be in the form of a series of spaced-apart stripes or spaced-apart markings. It can be appreciated that during the coating process, the order of application of the first and second coating can be switched, i.e. the “second” coating to the No. 2 surface can be applied before the application of the “first” coating to the No. 1 surface.

In accordance with yet another aspect, the present invention is directed to an architectural insulating glass unit comprising a first substrate having a No. 1 surface and a No. 2 surface, a second substrate having a No. 3 surface and a No. 4 surface, wherein the second substrate is spaced from the first substrate, and wherein the first substrate and the second substrate are associated with each other to define a gap therebetween, wherein the No. 2 and the No. 3 surfaces are facing each other and define the gap between the first substrate and the second substrate, a first coating on the No. 1 surface comprising a coating having a predetermined pattern; and a second coating located on at least the No. 2 surface, the No. 3 surface, or the No. 4 surface, wherein the predetermined pattern results in a contrast in the UV and/or bird-visible range when compared to other portions of the No. 1 surface of the substrate. According to one embodiment, the first coating can be applied to the No. 1 surface using an MSVD coating process and the predetermined pattern can comprise a series of spaced markings or spaced stripes. The predetermined pattern can be created by using a mask located within the coating device or by selectively turning on/off the coating device. The first coating can comprise nanoparticles. The second coating can comprise at least a base layer, at least one metallic layer, and a top layer. It can be appreciated that the order of application of the coatings to the No. 1 surface and the No. 2 surface can be switched.

### BRIEF DESCRIPTION OF THE DRAWINGS

The invention is illustrated in the accompanying drawing figures wherein like reference characters identify like parts throughout. Unless indicated to the contrary, the drawing figures are not to scale.

FIG. 1 is a side schematic view of an architectural window in accordance with an embodiment of the invention.

FIG. 2A is a front view of a No. 1 surface of a window having a predetermined coated pattern in accordance with an embodiment of the invention.

FIG. 2B is a front view of a No. 1 surface of a window having another predetermined coated pattern in accordance with an embodiment of the invention.

FIG. 2C is a front view of a No. 1 surface of a window having another predetermined coated pattern in accordance with an embodiment of the invention.

FIG. 2D is a front view of a No. 1 surface of a window having another predetermined coated pattern in accordance with an embodiment of the invention.

FIG. 2E is a front view of a No. 1 surface of a window having another predetermined coated pattern in accordance with an embodiment of the invention.

FIG. 3A shows a schematic side view of a coating device for coating a No. 1 and a No. 2 surface of a substrate of a window in accordance with an embodiment of the invention.

FIG. 3B shows a schematic top view of the coating device of FIG. 3A in accordance with an embodiment of the invention.

FIG. 4 shows a schematic cross-sectional side view of an architectural insulating glass unit including a No. 1 surface having a predetermined coated pattern thereon in accordance with an embodiment of the invention.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Additionally, all documents, such as but not limited to, issued patents and patent applications, referred to herein are to be considered to be “incorporated by reference” in their entirety.

The discussion of the invention herein may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

The invention comprises, consists of, or consists essentially of, the following aspects of the invention, in any combination. Various aspects of the invention are illustrated in separate drawing figures. However, it is to be understood that this is simply for ease of illustration and discussion. In the practice of the invention, one or more aspects of the invention shown in one drawing figure can be combined with one or more aspects of the invention shown in one or more of the other drawing figures.

The following numbered clauses are illustrative of various aspects of the disclosure:
Clause 1: A coated substrate comprising a first substrate, the first substrate having a No. 1 surface and a No. 2 surface oppositely disposed from the No. 1 surface, wherein the No. 2 surface comprises a second coating thereon, and wherein the No. 1 surface includes a first coating having a predetermined pattern having a contrast in the UV and/or bird-visible range when compared to uncoated portions of the No. 1 surface or when compared to other coated portions of the No. 1 surface, wherein the first coating forms a contrasting surface on the first substrate that reduces bird collisions with the substrate.
Clause 2: The coated substrate of clause 1, wherein the first coating is applied to the No. 1 surface using at least one of a chemical vapor deposition (CVD) process and a physical vapor deposition (PVD) process.
Clause 3: The coated substrate of clause 1, wherein the first coating is applied using a magnetron sputter vapor deposition (MSVD) coating process.
Clause 4: The coated substrate of any of clauses 1-3, wherein the predetermined pattern comprises a series of spaced markings.
Clause 5: The coated substrate of any of clauses 1-3, wherein the predetermined pattern comprises a series of stripes.
Clause 6: The coated article of any of clauses 1-5 wherein the at least one functional coating located on the No. 2 surface comprises at least a base layer, at least one metallic layer, and at least a top layer.
Clause 7: The coated substrate of clause 6, wherein the at least one functional layer comprises a second coating applied using an MSVD coating process.
Clause 8: The coated article of any of clauses 1-7, wherein the first coating comprises nanoparticles.
Clause 9: The coated substrate of clause 8, wherein the first coating comprises a silicon nitride or a metallic oxide and wherein the nanoparticles are embedded therein.
Clause 10: A method of forming an architectural window for reducing bird collisions with the window, the method comprising: providing a substrate having a No. 1 surface and an oppositely disposed No. 2 surface; moving the substrate through a coating device; applying a first coating to the No. 1 surface, wherein the first coating has a predetermined pattern that forms a contrasting surface on the substrate; and applying a second coating to the No. 2 surface, wherein the second coating comprises a series of coatings to form a functional layer on the No. 2 surface, wherein the predetermined pattern results in a contrast in the UV and/or bird visible range when compared to uncoated portions of the No. 1 surface of the substrate or when compared to other coated portions of the No. 1 surface of the substrate.
Clause 11: The method of clause 10, wherein the coating device is an MSVD coating device and the second coating is applied to the No. 2 surface using a sputter-down process.
Clause 12: The method of clause 10 or clause 11, wherein the first coating is applied to the No. 1 surface in the MSVD coating device using a sputter-up process.
Clause 13: The method of clause 12, wherein the substrate is continuously moved through the coating device and the second coating applied to the No. 2 surface, and the first coating applied to the No. 1 surface is applied in a single pass of the substrate through the MSVD coating device.
Clause 14: The method of any of clauses 10-13, wherein the predetermined pattern is applied to the No. 1 surface using a mask.
Clause 15: The method of any of clauses 10-14, wherein movement of the substrate through the coating device creates a striped pattern on the No. 1 surface.
Clause 16: The method of any of clauses 10-15, wherein the first coating can be selectively applied to the No. 1 surface by turning on/off the coating device that controls the application of the first coating.
Clause 17: The method of any of clauses 10-16, wherein the first coating comprises nanoparticles.
Clause 18: An architectural insulating glass unit comprising: a first substrate having a No. 1 surface and a No. 2 surface; a second substrate having a No. 3 surface and a No. 4 surface, wherein the second substrate is spaced from the first substrate, and wherein the first substrate and the second substrate are associated with each other to define a gap therebetween, wherein the No. 2 surface and the No. 3 surfaces are facing each other and define the gap between the first substrate and the second substrate; a first coating on the No. 1 surface comprising a coating having a predetermined pattern; and a second coating located on at least the No. 2 surface, the No. 3 surface, or the No. 4 surface, the second coating comprising at least one functional layer; wherein the predetermined pattern results in a contrast in the UV and/or bird-visible range when compared to uncoated portions of the No. 1 surface of the first substrate or when compared to other portions of the No. 1 surface of the first substrate.
Clause 19: The architectural insulating unit of clause 18, wherein the first coating is applied to the No. 1 surface using an MSVD coating process and the predetermined pattern comprises at least one of a series of spaced markings, a series of stripes, and a combination thereof.
Clause 20: The architectural insulating unit of clause 18 or clause 19, wherein the first coating comprises nanoparticles.

It will be readily appreciated by those skilled in the art that modifications may be made to the invention without departing from the concepts disclosed in the foregoing description. Accordingly, the particular embodiments described in detail herein are illustrative only and are not limited to the scope of the invention, which is to be given the full breadth of the appended claims and any and all equivalents thereof.

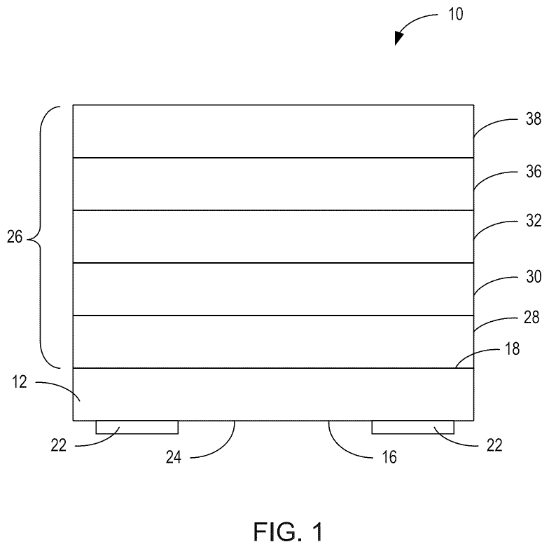

Reference is now made to FIG. 1, which shows a schematic side view of a coated substrate, generally indicated at 10, in accordance with an embodiment of the invention. The coated substrate 10 comprises a substrate 12 having a No. 1 surface 16 and a No. 2 surface 18 oppositely disposed from the No. 1 surface 16. The No. 1 surface 16 includes a first coating 22 having a bird-visible predetermined pattern on a portion of the No. 1 surface 16 with respect to other portions 24 of the No. 1 surface. The substrate 12 can comprise glass, plastic, ceramic, combinations thereof and the like. The No. 1 surface 16 can be a “raw” or uncoated glass. Alternatively, the No. 1 surface 16 can be coated, such as with a solar control coating, a protective coating, or any other type of coating. The first coating 22 having the bird-visible predetermined pattern comprises a material having a large contrast in the UV and/or visible range when compared to uncoated or “raw” portions 24 of the No. 1 surface 16 or, alternatively, when compared to other portions 24 of the No. 1 surface 16 that are only coated with the above-noted solar control, protective, or any other type of coating.

The first coating 22 in the predetermined pattern on the No. 1 surface 16 results in bird-visible portions on the No. 1 surface 16 that may scatter, redirect, absorb, reflect or transmit differently than other portions of the substrate. Incoming radiation, such as from sunlight or another radiation source, may be incident to the first coating 22, such that the incoming radiation collides with the first coating 22. The incoming radiation may comprise visible electromagnetic radiation and may comprise ultraviolet and/or infrared radiation. Upon the incoming radiation colliding with the first coating 22, the first coating 22 may reflect radiation in at least one direction away from the No. 1 surface 16. The reflected radiation may be scattered. By “scattered”, it is meant that the incoming radiation is reflected in non-specular directions to form the scattered radiation.

The first coating 22 forming the predetermined pattern can comprise a material including nanoparticles distributed therein resulting in the production of the predetermined patterned portion that reflects and/or absorbs radiation in the ultraviolet range and/or the visible region of the electromagnetic spectrum. It can be appreciated that the first coating 22 can comprise silicon nitride or various oxides, such as titanium dioxide, zinc oxide, tin oxide, zinc stannate, etc. in which the nanoparticles are embedded therein. According to one embodiment, the nanoparticles can be deposited in a polymer matrix. Examples of suitable nanoparticles include oxide nanoparticles, such as metal oxide nanoparticles. For example, alumina, titania, cerium oxide, zinc oxide, tin oxide, silica, and zirconia. Other examples include metallic nanoparticles, such as iron, steel, copper, silver, gold, and titanium. Further examples include alloy nanoparticles containing alloys of two or more materials, sulfide-containing nanoparticles and/or nitride-containing nanoparticles, luminescent materials and/or phosphorescent nanoparticles, and/or nanocrystalline nanoparticles. Examples of nanoparticles are described for example in U.S. Pat. Nos. 10,112,208; 10,112,209; and 10,597,324.

The No. 2 surface 18 comprises at least one functional layer or second coating, generally indicated as 26, located thereon. According to one embodiment, the second coating 26 on the No. 2 surface 18 can comprise layers that are applied as successive layers. The second coating 26 can be applied using an MSVD coating process or any other known coating process. The second coating 26 includes at least a base layer, such as a first dielectric layer 28, at least one metallic layer 30, and at least a top layer, such as a second dielectric layer 36. The second coating 26 can also include at least one primer layer 32, which is applied or coated over the at least one metallic layer 30. Also, at least one protective layer 38 can be applied or coated over the top layer or second dielectric layer 36. The primer layer 32 comprises any known primer layer. The primer layer is generally deposited as a metal and the metal subsequently oxidizes. The metal can be any metal known to be used in a primer layer, such as titanium, an aluminum doped zinc, nickel chromium, and the like. The first and second dielectric layers 28, 36 can be any known dielectric layer, such as the oxide of a zinc-based alloy or the like. The at least one protective layer 38 can be any known protective material, such as titania, silica, zirconia, alumina, an alloy of titania and alumina, mixtures thereof, and the like.

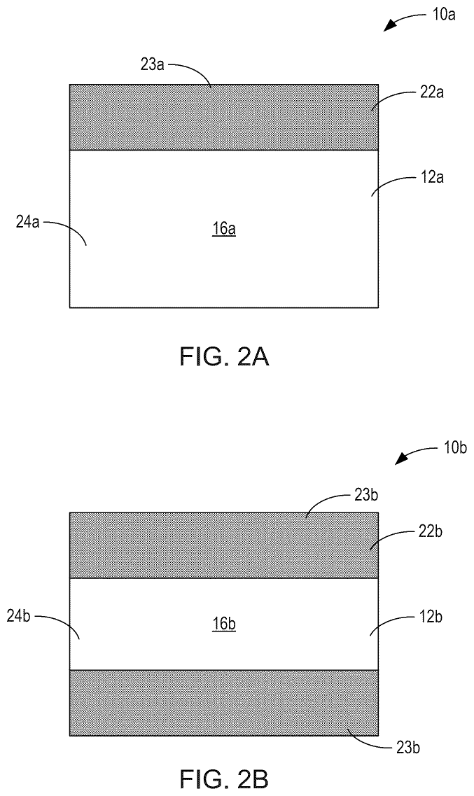

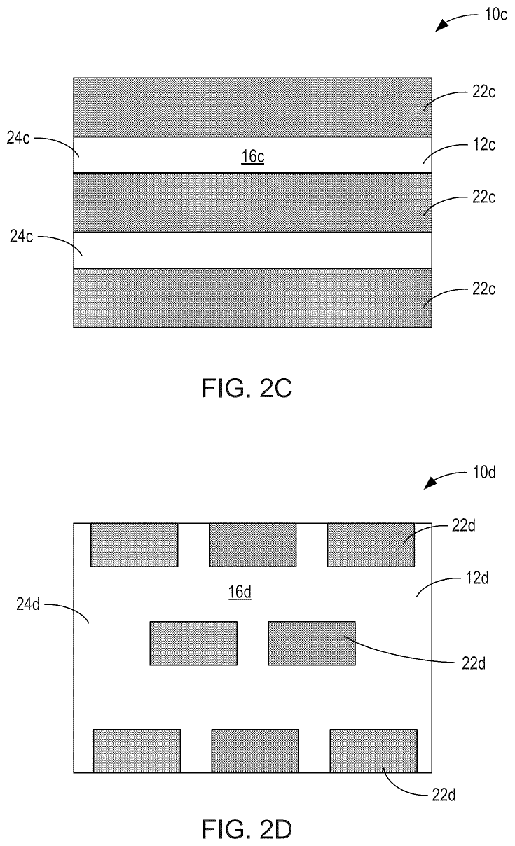

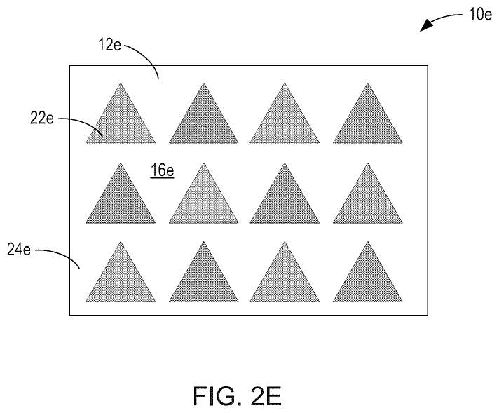

Referring to FIGS. 2A-2E, the coated substrates 10a-10e can have a variety of different coating patterns 22A-22E applied to the No. 1 surface 16a-16e of the substrate 12a-12e. These various patterns provide a contrast to uncoated or other portions 24a-24e of the coated substrate 10a-10e, which reduces bird collisions with the substrate 12. For example, the different coating patterns 22 can be a single stripe 22a running adjacent to an edge 23a, leaving an uncoated or other portion 24a on the No. 1 surface 16a, as illustrated in FIG. 2A. Another coating pattern 22 can be a pair of stripes 22b running adjacent to a pair of edges 23b, leaving an uncoated center portion 24b on the No. 1 surface 16b, as illustrated in FIG. 2B. As illustrated in FIG. 2C, the pattern on the coated substrate 10c can comprise a series of alternating stripes 22c and uncoated or other portions 24c located on the No. 1 surface 16c. According to another embodiment, the coating pattern 22 can be a series of discrete shaped markings having a variety of shapes, such as rectangles 22d as shown in FIG. 2D, or triangles 22e, as illustrated in FIG. 2E, contrasting to the uncoated portions 24d and 24e on the No. 1 surface 16d and 16e, respectively. It can be appreciated that any variety of stripes, shapes, and/or any combination thereof can be coated onto the No. 1 surface 16 to create the pattern 22. It can also be appreciated that the pattern distribution can be periodic, quasi-periodic, or random. According to one embodiment, the predetermined pattern in the first coating can be such that there is, at most, a 4-inch linear space between each pattern within the first coating. The spacing can be designed so that a bird of any size flying toward the window 10 perceives the window 10 and does not mistake a gap between the contrasting coatings 22 for an area in which the bird can fly through.

The method of forming the coated substrate 10 comprises providing a substrate 12 having a No. 1 surface 16 and an oppositely disposed No. 2 surface 18, moving the substrate 12 through a coating device and applying a first coating 22 to the No. 1 surface 16. The first coating 22 has a predetermined pattern that forms a contrasting surface on the substrate. The predetermined pattern results in a contrast in the UV and/or visible range when compared to other portions 24 of the No. 1 surface 16 of the substrate 12. The method further comprises applying a functional layer(s) to the No. 2 surface 18. This functional layer(s) can be in the form of one or more second coatings 26 applied onto the No. 2 surface 18. It can be appreciated that in the manufacturing line, the second coatings 26 or the functional layers can be applied to the No. 2 surface 18 before the application of the first coating 22 or patterned coating to the No. 1 surface 16.

The first and second coatings 22, 26 can be applied using any well-known coating devices, such as, conventional chemical vapor deposition (CVD) or physical vapor deposition (PVD) devices, and the like. Examples of CVD processes include spray pyrolysis. Examples of PVD processes include electron beam evaporation and vacuum sputtering (such as, magnetron sputter vapor deposition (MSVD)). Other coating methods could also be used, such as, but not limited to, sol-gel deposition, slot die coating deposition, or printing depositions, such as screen printing or ink-jet printing. In one non-limiting embodiment, the first and second coatings 22, 26 are deposited by MSVD. Examples of MSVD coating devices are described, for example, in U.S. Pat. Nos. 4,379,040; 4,861,669; 4,898,789; 4,898,790; 4,900,633; 4,920,006; 4,938,857; 5,328,768; and 5,492,750.

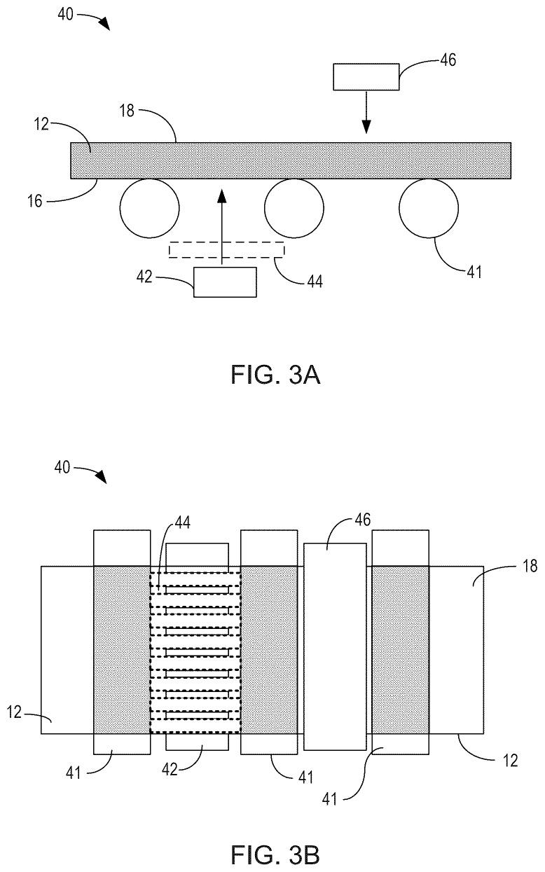

According to one embodiment, and with reference to FIGS. 3A and 3B, the first coating 22 can be applied to the No. 1 surface 16 and the second coating 26 can be applied to the No. 2 surface 18 of the substrate 12 by moving the substrate 12 through a magnetron sputtering deposition MSVD coating device, generally indicated as 40. It can be appreciated that the substrate 12 can be moved continuously through the MSVD device 40 via a series of rollers 41. The first coating 22 can be a predetermined pattern comprising a series of spaced markings that contrast with other portions 24 of the substrate having patterns such as shown in FIGS. 2A-2E. The first coating 22 is applied to the No. 1 surface 16 using a sputter-up device 42 and a mask 44 located within the coating device 40. Instead of using a mask 44, the first coating 22 can be selectively applied to the No. 1 surface 16 by turning on/off the coating device, such as the sputter-up device 42 that controls the application of the first coating 22. These contrasting areas/patterns created by the first coating 22 reduce the bird collisions with the coated substrate 10. The second coating/functional layer 26 can be applied to the No. 2 surface 18 as a series of coatings using a sputter-down device 46. Using the particular MSVD coating device 40 as described in the present invention in which both a sputter-up device 42 and a sputter-down device 46 is provided results in a significant cost saving as it allows for the coating of both the No. 1 surface 16 and the No. 2 surface 18 in a single pass through the MSVD coating device 40. The particular system of the present invention eliminates the time-intensive/labor-intensive task of applying a coating to one surface of the substrate, flipping this substrate over, and subsequently coating the opposite surface.

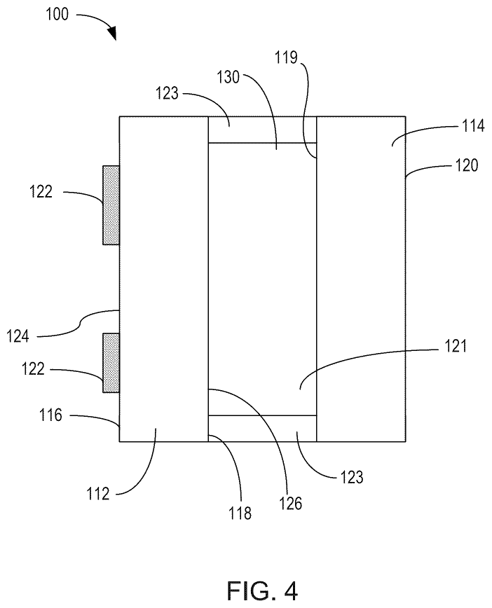

Reference is now made to FIG. 4, which illustrates an architectural insulating glass unit, generally indicated as 100, in accordance with another embodiment of the invention. Examples of insulating glass units are found, for example, in U.S. Pat. Nos. 4,193,236; 4,464,874; 5,088,258; and 5,106,663. The insulating glass unit comprises a first substrate 112 having a No. 1 surface 116 and a No. 2 surface 118, a second substrate 114 having a No. 3 surface 119 and a No. 4 surface 120. The second substrate 114 is spaced from the first substrate 112 and the first substrate 112 and the second substrate 114 are associated with each other to define a gap 121 therebetween. The No. 2 surface 118 and the No. 3 surface 119 face each other and can be connected in any suitable manner, such as by being adhesively bonded to a conventional spacer frame 123 to define the gap 121 between the first substrate 112 and the second substrate 114. According to one embodiment, the gap 121 can be filled with a selected atmosphere 130, such as gas, for example, air, or a non-reactive gas such as argon or krypton gas. According to another embodiment, the gap 121 may be evacuated to produce a vacuum (a vacuum-insulating glass unit). Additionally, or alternatively to being vacuum filled or gas filled, the gap 121 may contain a liquid, gel, solid, or combination thereof. The gap 121 may also contain a mechanical structure such as movable blinds.

When installed in a building, the No. 1 surface 116 faces the outside of the building and the No. 4 surface 120 faces the inside of the building. A first coating 122 is provided on the No. 1 surface 116 comprising a coating having a predetermined pattern. The predetermined pattern results in a contrast in the UV and/or visible light spectrum when compared to other portions 124 of the No. 1 surface 116 of the substrate 112. It can be appreciated that the predetermined pattern of the first coating 122 can be any variety of stripes, shapes, and/or any combination thereof, including, but not limited to, the patterns illustrated in FIGS. 2A-2E.

Alternatively, the invention can be a monolithic laminate architectural window. When installed in a building, the No. 1 surface faces the outside of the building and the No. 2 surface faces that inside of the building. The first coating 122 is provided on the No. 1 surface. Like the IGU example, the first coating has a predetermined pattern that results in a contrast in the UV and/or visible light spectrum when compared to other portions of the No. 1 surface of the substrate.

A second coating 126 is located on at least the No. 2 surface 118, the No. 3 surface 119, and/or the No. 4 surface 120; or the No. 2 surface of a monolithic laminate window. For illustration purposes, FIG. 4 shows the second coating 126 located on the No. 2 surface 118. The second coating 126, as shown for example as reference number 26 in FIG. 1, can comprise at least a base layer, such as a first dielectric layer 28; at least one metallic or layer 30, at least one primer layer 32, at least a top layer, such as a second dielectric layer 36, and at least an optional protective layer 38.

According to one embodiment, and with reference to FIGS. 3A and 3B, the first coating 122 can be applied to the No. 1 surface 116 using a sputter-up device 42 in an MSVD coating process/device 40. The predetermined pattern of the first coating 122 can be created by using a mask 44 located in the device 40, as shown in FIGS. 3A and 3B, or by selectively turning on/off the coating device. The at least one functional layer 126 located on at least the No. 2 surface 118, the No. 3 surface 119, or the No. 4 surface 120 can comprise a coating stack, as discussed above wherein the layers are applied as a coating using a sputter-down arrangement 46 in an MSVD coating process/device 40 of FIGS. 3A and 3B.

It can be appreciated that the substrate 12, the first substrate 112, and/or the second substrate 114 can be glass, ceramic, and/or plastic, as long as the material used is not detrimentally affected by the operating conditions of the coating process. It can also be appreciated that the first substrate 112 and the second substrate 114 can be of the same or different materials and can include any desired material having any desired characteristics. For example, one or more of the substrates 112, 114 can be transparent or translucent to visible light.

The substrate, the first substrate and/or the second substrate 12, 112, 114 can comprise glass. Non-limiting examples of suitable glass materials include soda-lime-silicate glass, borosilicate glass, or leaded glass. The glass can be of any type, such as float glass, and can be of any composition having any optical properties, e.g., any value of visible transmission, ultraviolet transmission, infrared transmission, and/or total solar energy transmission. By “float glass” is meant glass formed by a float process in which molten glass is deposited onto a molten metal bath and controllably cooled to form a float glass ribbon.

Alternatively, the substrate, 12, the first substrate 112 and/or the second substrate 114 can comprise plastic. Non-limiting examples of suitable plastic materials for the substrate 12 and/or the first and second substrates 112, 114 include acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof.

The substrate 12, the first substrate 112, and the second substrate 114 can be of any desired dimensions, e.g., length, width, shape, or thickness. In one non-limiting embodiment substrates 12, 112, 114 are components in an architectural transparency, each substrate 12, 112, 114 may be 1-30 mm thick, such as 2.5-25 mm thick, or 2.5-10 mm thick.

The first coating 22, 122 and the predetermined pattern may be visible to both birds and humans, such that they are visible by reflecting radiation in the visible region (approximately 380-750 nm) of the electromagnetic spectrum. The patterns may exhibit a low gloss value at 20°, such as the coatings 22, 122 having a 20° gloss value of less than 1 gloss unit, less than 0.5 gloss units, or less than 0.25 gloss units. 20° gloss value may be measured using a gloss meter.

The No. 1 surface 16, 116 may be an uncoated surface. Alternatively, the No. 1 surface 16, 116 may be coated, such as with a solar control coating, a protective coating, or any other type of coating.

As discussed above and in reference to FIG. 4, the first coating 122 may scatter bird-visible incident electromagnetic radiation. Incoming radiation, such as from sunlight or another radiation source, may be incident to the first coating 122, such that the incoming radiation collides with the first coating 122. The incoming radiation may comprise bird-visible electromagnetic radiation and may comprise ultraviolet and/or infrared radiation. Upon the incoming radiation colliding with the first coating 122, the first coating 122 may reflect radiation (i.e., the scattered radiation) in at least one direction away from the No. 1 surface 116. By “scattered”, it is meant that the incoming radiation is reflected in non-specular directions to form the scattered radiation.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A coated substrate comprising a first substrate, the first substrate having a No. 1 surface and a No. 2 surface oppositely disposed from the No. 1 surface, wherein the No. 2 surface comprises a second coating located thereon, and wherein the No. 1 surface comprises a first coating having a predetermined pattern, wherein the first coating comprises a material having a contrast in the UV and/or bird-visible range when compared to uncoated portions of the No. 1 surface or when compared to other coated portions of the No. 1 surface, wherein the first coating forms a contrasting surface on the first substrate that reduces bird collisions with the substrate.

2. The coated substrate of claim 1, wherein the first coating is applied to the No. 1 surface using at least one of a chemical vapor deposition (CVD) process and a physical vapor deposition (PVD) process.

3. The coated substrate of claim 2, wherein the first coating is applied using a magnetron sputter vapor deposition (MSVD) coating process.

4. The coated substrate of claim 1, wherein the predetermined pattern comprises a series of spaced markings that are created using a mask.

5. The coated substrate of claim 1, wherein the predetermined pattern comprises a series of stripes.

6. The coated substrate of claim 1, wherein the at least one functional layer located on the No. 2 surface comprises at least a base layer, at least one metallic layer, at least one primer layer, a top layer, and a protective layer.

7. The coated substrate of claim 6, wherein the at least one functional layer comprises a second coating applied using an MSVD coating process.

8. The coated substrate of claim 1, wherein the first coating comprises nanoparticles.

9. The coated substrate of claim 8, wherein the first coating comprises a silicon nitride or a metallic oxide and wherein the nanoparticles are embedded therein.

10. A method of forming an architectural window for reducing bird collisions with the window, the method comprising:
providing a substrate having a No. 1 surface and an oppositely disposed No. 2 surface;
moving the substrate through a coating device;
applying a first coating to the No. 1 surface, wherein the first coating has a predetermined pattern that forms a contrasting surface on the substrate; and
applying a second coating to the No. 2 surface, wherein the second coating comprises a series of coatings to form a functional layer on the No. 2 surface,
wherein the predetermined pattern results in a contrast in the UV and/or bird-visible range when compared to uncoated portions of the No. 1 surface of the substrate or when compared to other coated portions of the No. 1 surface of the substrate.

11. The method of claim 10, wherein the coating device is an MSVD coating device and the second coating is applied to the No. 2 surface using a sputter-down process.

12. The method of claim 11, wherein the first coating is applied to the No. 1 surface in the MSVD coating device using a sputter-up process.

13. The method of claim 12, wherein the substrate is continuously moved through the coating device and the second coating applied to the No. 2 surface, and the first coating applied to the No. 1 surface is applied in a single pass of the substrate through the MSVD coating device.

14. The method of claim 10, wherein the predetermined pattern is applied to the No. 1 surface using a mask located within the coating device.

15. The method of claim 10, wherein movement of the substrate through the coating device creates a striped pattern on the No. 1 surface.

16. The method of claim 10, wherein the first coating can be selectively applied to the No. 1 surface by turning on/off the coating device that controls the application of the first coating.

17. The method of claim 10, wherein the first coating comprises nanoparticles.

18. An architectural insulating glass unit comprising:
a first substrate having a No. 1 surface and a No. 2 surface;
a second substrate having a No. 3 surface and a No. 4 surface, wherein the second substrate is spaced from the first substrate, and wherein the first substrate and the second substrate are associated with each other to define a gap therebetween, wherein the No. 2 surface and the No. 3 surfaces are facing each other and define the gap between the first substrate and the second substrate;
a first coating on the No. 1 surface comprising a coating having a predetermined pattern; and
a second coating located on at least the No. 2 surface, the No. 3 surface, or the No. 4 surface, the second coating comprising at least one functional layer;
wherein the predetermined pattern results in a contrast in the UV and/or bird-visible range when compared to uncoated portions of the No. 1 surface of the first substrate or when compared to other coated portions of the No. 1 surface of the first substrate.

19. The architectural insulating unit of claim 18, wherein the first coating is applied to the No. 1 surface using an MSVD coating process and the predetermined pattern comprises at least one of a series of spaced markings, a series of stripes, and a combination thereof.

20. The architectural insulating unit of claim 18, wherein the first coating comprises nanoparticles.
